(19) United States
(12) Patent Application Publication
(10) Pub. No.: US 2004/0127698 A1
(43) Pub. Date: Jul. 1, 2004

(54) Method for producing double-crosslinked hyaluronate material

(75) Inventors: Shiao-Wen Tsai, Taipei (TW); Chiung-Lin Yang, Hsinchu (TW); Jui-Hsiang Chen, Hsinchu (TW); Pei-Ching Chang, Changhua (TW); Li-Ting Su, Taipei (TW); Shu-Hua Jan, Changhua (TW)

Correspondence Address: SUGHRUE MION, PLLC, 2100 PENNSYLVANIA AVENUE, N.W., SUITE 800, WASHINGTON, DC, 20037, US

(73) Assignee: INDUSTRIAL TECHNOLOGY RESEARCH INSTITUTE

(21) Appl. No.: 10/743,835

(22) Filed: Dec. 24, 2003

(30) Foreign Application Priority Data
Dec. 31, 2002 (TW) 91138117

(51) Int. Cl. C08B 37/00

(52) U.S. Cl. 536/53

(57) ABSTRACT

A method for producing a double-crosslinked hyaluronate material. A hyaluronic acid or a salt thereof is sequentially reacted with an epoxide compound and a carbodiimide compound to produce a more biodegradation-resistant hyaluronate material.

### BACKGROUND OF THE INVENTION

1. Field of the Invention

The present invention relates to a method for producing double-crosslinked hyaluronate material, and in particular, to a method for producing double-crosslinked hyaluronate material with increased biodegradation-resistant properties.

2. Description of the Related Art

Hyaluronic acid (HA) is a mucopolysaccharide occurring naturally in vertebrate tissues and fluids, a linear polymer having a high molecular weight usually varying within the range of several thousand to several million daltons depending on its source and purification methods. HA has a disaccharide repeating unit composed of N-acetyl-D-glucosamine and D-glucuronic acid linked together by a beta 1-3 glucuronic bond, and the dimer repeating units are joined by beta 1-4 glucosaminidic bonds, so that beta 1-3 glucuronic and beta 1-4 glucosaminidic bonds alternate along the chain. HA is widely distributed in connective tissues, mucous tissues, and capsules of some bacteria.

It has been reported that HA, whose advantages include natural occurrence in the body, freedom from immuno-reactivity, degradability and absorbability in vivo, and mass-producability, is often used in medicine. A major application of HA is in the ophthalmic surgical remedy of cataracts and cornea damage. High molecular HA solution is injected into the eye as a viscoelastic fluid, and plays a special role in maintaining morphology and function. HA can also be used in treatment of arthritis and has been recently applied in wound healing, anti-adhesion of tissue after operation, and drug release. HA also plays an important role in cosmetics in anti-aging cosmetic applications owing to its high water retention.

Accordingly, there has been much research concerning HA. K. Tomihata et al., 1997, Biomaterials, vol. 18, page 189-195, studied the crosslinking of HA in an aqueous solution effected at various pH values by poly(ethylene glycol) diglycidyl ether, a diepoxy compound, as a crosslinking agent. The result showed that 6.1 was the optimal pH value for the crosslinking reaction of HA molecules exerted by diepoxy compounds.

U.S. Pat. No. 4,963,666 issued to Malson discloses a process for producing polysaccharides containing carboxyl groups, which comprises, first, reacting a polysaccharide containing carboxyl groups (such as hyaluronic acid) with a bi- or polyfunctional epoxide under a base condition, resulting in a water-soluble, non-gelatinous epoxy-activated polysaccharide, second, removing any un-reacted epoxide by, for example, dialysis, and, third, placing the activated polysaccharide in a mold and allowing it to dry. The epoxy-activated polysaccharides become crosslinked during drying.

U.S. Pat. No. 4,716,224 issued to Sakurai et al. discloses a process for producing crosslinked hyaluronic acid or salt thereof, wherein the crosslinking agent is a polyfunctional epoxy compound including halomethyloxirane compounds and a bisepoxy compound. The crosslinked product has a crosslinking index of 5 to 20 per 100 repeating disaccharide units and is water soluble and stringy.

U.S. Pat. No. 5,017,229 issued to Burns et al. discloses a method for making a water insoluble derivative of hyaluronic acid, comprising combining an aqueous solution of HA with a solid content of 0.4% to 2.6% w/w, a polyanionic polysaccharide, and an activating agent, for example, EDC (1-ethyl-3-(3-dimethylaminopropyl carbodiimide hydrochloride) at pH 4.75 to form a water insoluble hydrogel of hyaluronic acid.

U.S. Pat. No. 5,527,893 issued to Burns et al. discloses a method of making water insoluble derivatives of polyanionic polysaccharides, characterized by an acyl urea derivative of hyaluronic acid added during the crosslinking of HA with EDC, to produce a modified hyaluronic acid hydrogel.

U.S. Pat. No. 5,356,883 issued to Kuo et al. discloses a method for preparing water-insoluble hydrogels, films, and sponges from hyaluronic acid by reacting HA, or a salt thereof, in HA solution with EDC crosslinking agent. After reaction, the product precipitates upon the addition of ethanol, giving a water-insoluble gel.

U.S. Pat. No. 5,502,081 issued to Kuo et al. describes a substance having pharmaceutical activity covalently bonding to the polymer chain of hyaluronic acid through the reaction of a carbodiimide compound.

U.S. Pat. No. 6,013,679 issued to Kuo et al. discloses a method for preparing water insoluble derivatives of hyaluronic acid, wherein carbodiimide compounds are used as crosslinking agents for hyaluronic acid to form water insoluble derivatives.

WO 86/00912 (De Bedler et al.) describes a method for producing a gel for preventing tissue adhesion following surgery, including crosslinking a carboxyl-containing polysaccharide (such as hyaluronic acid) with a bi- or poly-functional epoxide compound to form a gel of crosslinked hyaluronic acid.

WO 86/00079 (Malson et al.) describes a method of preparing gels of crosslinked HA, in which the crosslinking agent is a bifunctional or polyfunctional epoxide, or a corresponding halohydrin or epihalohydrin or halide. The product obtained is a sterile and pyrogen-free gel of hyaluronic acid.

WO 90/09401 and U.S. Pat. No. 5,783,691 issued to Malson et al. disclose a process for preparing gels of crosslinked hyaluronic acid, characterized by phosphorus-containing reagent use as the crosslinking agent.

U.S. Pat. No. 4,716,154 issued to Malson et al. describes a method for producing gels of crosslinked hyaluronic acid for use as a vitreous humor substitute. The method is characterized by the gels of crosslinked hyaluronic acid being produced with polyfunctional epoxide, or halohydrin or epihalohydrin or halide as a crosslinking agent. The examples show that gels of HA can be formed by adding epoxide, such as BDDE, to basic HA solution when the solid content of HA in HA solution is more than 13.3% and the reaction temperature is higher than 50° C.

Nobuhiko et al., Journal of Controlled Release, 25, 1993, page 133-143, disclose a method for preparing lipid microsphere-containing crosslinked hyaluronic acid. A basic solution of hyaluronic acid in NaOH solution with 20 wt % solid content of hyaluronic acid has suitable amounts of polyglycerol polyglycidyl ether (PGPGE) added to it, PGPGE/repeating units of HA (mole/mole) is about 1.0, and the mixture is reacted at 60° C. for 15 minutes, giving a gel of crosslinked HA.

Nobuhiko et al., Journal of Controlled Release, 22, 1992, page 105-106, disclose a method for preparing gels of crosslinked hyaluronic acid. A basic solution of hyaluronic acid in NaOH solution with 20 wt % solid content of hyaluronic acid has a solution of EGDGE (ethylene glycol diglycidyl ether) or PGPGE epoxide in ethanol added to it, and the mixture is reacted at 60° C. for 15 minutes, giving a gel of crosslinked HA.

U.S. Pat. Nos. 4,582,865 and 4,605,691 issued to Balazs et al. disclose a method for preparing crosslinked gels of hyaluronic acid and products containing such gels. The crosslinked gels of HA are formed by reaction of HA solution and divinyl sulfone as crosslinking agent under the condition of pH above 9.0.

U.S. Pat. No. 4,937,270 issued to Hamilton et al. discloses a method for producing water insoluble HA hydrogels, in which EDC and L-leucine methyl ester hydrochloride are used as crosslinking agents for hyaluronic acid.

U.S. Pat. No. 5,760,200 issued to Miller et al. discloses a method for producing water insoluble derivatives of polysaccarides. An acidic polysaccharide (such as hyaluronic acid) aqueous solution has EDC and L-leucine methyl ester hydrochloride as crosslinking agents for hyaluronic acid added, giving a water insoluble HA gel.

In view of the above, while there are currently technologies producing crosslinked hyaluronic acid materials by crosslinking hyaluronic acid with epoxides or carbodiimides, the crosslinked hyaluronic acid materials obtained have a limited resistance to biodegradation.

### SUMMARY OF THE INVENTION

Accordingly, an object of the invention is to provide a method for producing double-crosslinked hyaluronate material.

The novel method of the present invention is very different from the current technologies, in which double crosslink is performed by the crosslinking reaction on the carboxyl and hydroxyl groups in the structure of hyaluronic acid molecule respectively and sequentially with carbodiimides (for carboxyl and hydroxyl groups) and epoxides (for hydroxyl groups) or epoxides and carbodiimides, as shown by the following scheme:

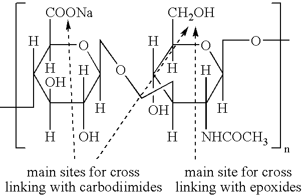

to obtain double-crosslinked hyaluronate materials. The method is novel. The double-crosslinked hyaluronate material obtained thereby has excellent resistance to biodegradation or deterioration by hydrolysis, as well as mechanical strength (that is, the feeling for stiffness upon physiological operation) over the hyaluronic acid materials obtained from the crosslinking with epoxides or carbodiimides alone and can be more advantageously applied in vivo. The method of the invention can be mass produced for crosslinked hyaluronate materials, having a high potential for use in the industry.

### BRIEF DESCRIPTION OF THE DRAWINGS

FIG. 1a is a graph illustrating an FTIR spectrum obtained on the film from the product of hyaluronic acid being crosslinked by only the epoxide in Example 3 of the specification.

FIG. 1b is a graph illustrating an FTIR spectrum obtained on the film from the product of hyaluronic acid being double crosslinked by epoxide and carbodiimide sequentially in Example 3 of the specification.

### DETAILED DESCRIPTION OF THE INVENTION

The method for producing double-crosslinked hyaluronate material includes the steps of (a) subjecting hyaluronic acid or a salt thereof to a first crosslinking reaction using either an epoxide compound or a carbodiimide compound as a crosslinking agent and (b) subjecting the product obtained from step (a) to a second crosslinking reaction using the epoxide compound or carbodiimide compound not used in step (b) as a crosslinking agent, thereby obtaining a double crosslinked hyaluronate material,

More specifically, in carrying out the sequential double crosslinking in the method of invention, the crosslinking agent in the first crosslinking reaction can be an epoxide compound, in which case the crosslinking agent in the second crosslinking reaction can be a carbodiimide compound; alternatively, if the crosslinking agent in the first crosslinking reaction is a carbodiimide compound, the crosslinking agent in the second crosslinking reaction can be an epoxide compound. Briefly, the order for using a carbodiimide compound and an epoxide compound as crosslinking agents to perform two crosslinking reactions respectively is interchangeable.

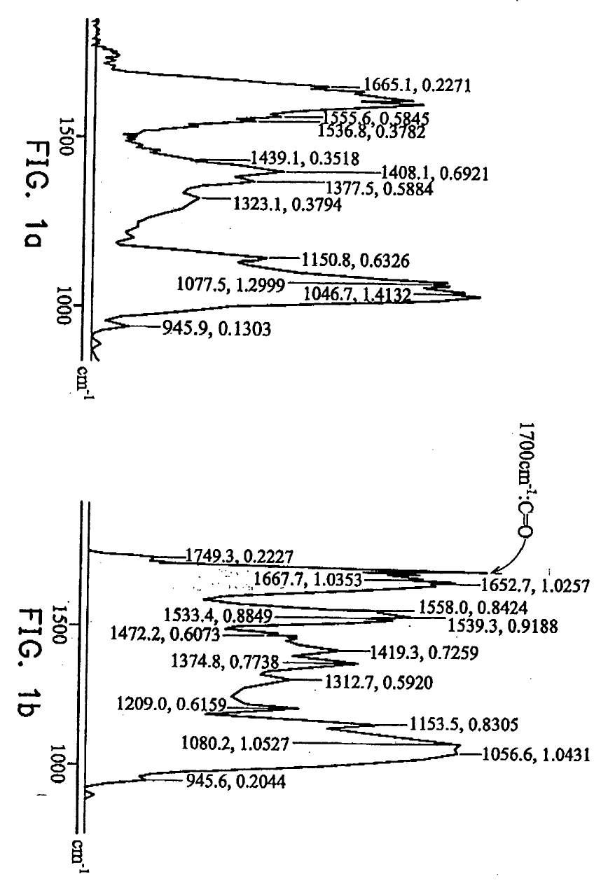

Referring to FIGS. 1a and 1b, FIG. 1a is a graph illustrating an FTIR spectrum obtained on the film from the product of hyaluronic acid being crosslinked with only the epoxide in Example 3 described below.

FIG. 1b is a graph illustrating an FTIR spectrum obtained on the film from the product of hyaluronic acid being double crosslinked by epoxide and carbodiimide sequentially in Example 3 described below. There is a peak at 1700 cm⁻¹ corresponding to C═O peak in FIG. 1b but not in FIG. 1a, confirming the result of double crosslinking after the crosslinking reaction with carbodiimide.

In the method of the present invention, the HA or the salt thereof may be contained in a material. The HA, the salt thereof, or the material may be preformed into a solution, film, membrane, powder, microsphere, fiber, filament, matrix, porous substrate or gel before undergoing the first crosslinking reaction with an epoxide compound or a carbodiimide compound, Alternatively, the product obtained from step (a) may be preformed into a solution, film, membrane, powder, microsphere, fiber, filament, matrix, porous substrate or gel before undergoing the second crosslinking reaction. Thus, the double crosslinked hyaluronate material produced by the method of the present invention can be obtained in a form of solution, film, membrane, powder, microsphere, fiber, filament, matrix, porous substrate, or gel.

The HA used in the present invention is a naturally occurring polysaccharide. The salt thereof may be in any form, such as alkali salt, alkali earth metal salt, ammonium salt, or hydrochloride salt.

In step (a), the HA is subjected to a crosslinking reaction (defined as “first crosslinking reaction” herein) using either an epoxide compound or a carbodiimide compound as a crosslinking agent.

The epoxide compounds useful in the present invention are epoxide compounds with poly-functionality, including bi-, tri-, and quad-functionality. Poly-functional epoxide compounds include, but not limited to, for example, 1,4-butanediol diglycidyl ether (BDDE), ethylene glycol diglycidyl ether (EGDGE), 1,6-hexanediol diglycidyl ether, polyethylene glycol diglycidyl ether, polypropylene glycol diglycidyl ether, polytetramethylene glycol digylcidyl ether, neopentyl glycol digylcidyl ether, polyglycerol polyglycidyl ether, diglycerol polyglycidyl ether, glycerol polyglycidyl ether, tri-methylolpropane polyglycidyl ether, pentaerythritol polyglycidyl ether, and sorbitol polyglycidyl ether. The epoxide compound may be in a solution with a concentration of about 0.5 to 30% by weight, preferably 1 to 30% by weight. The stoichiometry ratio of HA to the epoxide compound in the crosslinking reaction is about 1:50 to 1:1 by crosslinking equivalent. The crosslinking temperature is between about 20 and 60° C., preferably between about 20 and 50° C. The crosslinking time is more than 10 minutes, preferably between 30 minutes and 12 hours, more preferably between 60 minutes and 12 hours.

The carbodiimide compounds useful in the present invention include, but not limited to, for example, 1-methyl-3-(3-dimethylaminopropyl)carbodiimide, 1-ethyl-3-(3-dimethylaminopropyl)carbodiimide, 3-(3-dimethylaminopropyl)-3-ethylcarbodiimide, and a combination thereof. The carbodiimide compound may be in a solution with a concentration of about 0.5 to 30% by weight, preferably 1 to 30% by weight. The stoichiometry ratio of HA to the epoxide compound in the crosslinking reaction is about 1:50 to 1:1 by crosslinking equivalent. The crosslinking temperature is between about 20 and 60° C., preferably between about 20 and 50° C. The crosslinking time is more than 30 minutes, preferably between 30 minutes and 12 hours, more preferably between 60 minutes and 12 hours.

AS mentioned above, the HA, the salt thereof, or the material containing the same can be preformed into a solution, film, membrane, powder, microsphere, fiber, filament, matrix, porous substrate or gel before undergoing the first crosslinking reaction. The solvent used in the solution may be water.

A method for forming a film or membrane is exemplarily described as follows. A HA solution is formed and placed in a mold and dried to form a film or membrane with a thickness of from 10 to 500 μm. The HA concentration in the HA solution is preferably about 0.5 to 20% by weight, more preferably about 2.5 to 20% by weight. The mold material may be ceramic, metal, or polymer. The temperature for drying the film is between 25 and 70° C., preferably between 25 and 45° C.

A method for forming fiber, filament, or microsphere shaped substrate is exemplarily described as follows. A HA solution is formed and extruded into a coagulant containing organic solvent by an extruder to form fibrous HA fiber or filament, or HA solution intermittently extruded and dropped into the coagulant to form HA microsphere with a diameter of from 2.0 to 0.1 mm. The coagulant is composed of water and organic solvent. Suitable organic solvent is, for example, 1,4-dioxane, chloroform, methylene chloride, N,N-dimethylformamide (DMF), N,N-dimethylacetamide (DMF), ethyl acetate, ketones, such as acetone, and methyl ethyl ketone, or alcohols such as methanol, ethanol, propanol, isopropanol, and butanol. The total weight fraction of organic solvents in the coagulant is about 30 to 100%, and preferably about 50 to 100%. Ketones and alcohols can be used in any proportion.

A method for forming porous substrate is exemplarily described as follows. A HA solution is formed and placed in a mold of proper shape and subjected to freeze-drying, to obtain a porous structure having interconnected pore morphology.

After HA attains the desired shape, it may be placed in the solution of the crosslinking agent and subjected to the first crosslinking reaction.

The product obtained from the first crosslinking reaction may be washed by a cleaning solution to remove the crosslinking agent residue before being subjected to the second crosslinking reaction. The cleaning solution may be any solution capable of removing the crosslinking agent residue, and considering the usage of the product, solutions not harmful to health are preferred.

In step (b) of the present invention, the crosslinking agent used is the epoxide or carbodiimide compound not used in the first crosslinking reaction. That is, if epoxide compound is used as the crosslinking agent for crosslinking reaction in step (a), carbodiimide compound crosslinking agent is used as the crosslinking agent for the second crosslinking reaction in step (b); and vice versa. Suitable carbodiimide or epoxide compounds and the reaction conditions in step (b) are the same as those in step (a).

As mentioned above, if the solution of HA has not been preformed into a desired form, such as solution, film, membrane, powder, microsphere, fiber, filament, matrix, porous substrate and gel, before undergoing the first crosslinking reaction, this may be done before undergoing the second crosslinking reaction to endow the final product with a desired form.

The product obtained from the second crosslinking reaction in step (b) is a sequential double-crosslinked hyaluronate material. The product can be washed with cleaning solutions and water. Suitable cleaning solutions are organic solvent mixtures containing water. The organic solvents may be ketones, such as acetone and methyl ethyl ketone, or alcohols such as methanol, ethanol, propanol, isopropanol, and butanol. The total weight fraction of organic solvents in the cleaning solution is about 10 to 95%. Ketones and alcohols can be used in any proportion. The temperature for washing with the cleaning solution may be about 15 to 50° C., preferably about 20 to 50° C. After washing with the cleaning solution, the product, double-crosslinked hyaluronate material, is washed with water about 25 to 50° C., and then dried at 60° C. or less by hot air, radiation, or vacuum drying. The final product of sequential double-crosslinked hyaluronate material obtained can take the form of film, membrane, powder, microsphere, fiber, filament, matrix, porous substrate or gel depending on whether a specific shape has been imparted during the process. The double-crosslinked hyaluronate material has a low degradation rate in vitro and is suitable for medical or cosmetic use.

### EXAMPLE 1

### Method for Producing EDC-Epoxide Sequential Double-Crosslinked Hyaluronate Material

A solution of sodium hyaluronate (0.1 g of powder in 10 ml of distilled water) was prepared at room temperature, poured into a plate mold made of Teflon, and dried in an oven at 35° C., giving a hyaluronate film with a thickness of about 50 μm. The film was placed in an excessive EDC solution (2% by weight of EDC in acetone/water (70/30 v/v)) as a crosslinking agent to undergo a crosslinking reaction under a predetermined condition, as shown in Table 1. The resulting film was washed in a cleaning solution (a solution of 80% by weight of acetone in water) and then placed in an excessive EGDGE (epoxide) solution (2% by weight of EGDGE in acetone/water (70/30 v/v)) as a crosslinking agent to undergo a second crosslinking reaction under a predetermined condition, as shown in Table 1. The resulting film was washed in a cleaning solution (a solution of 50% by weight of acetone in water) several times, and then in distilled water. The epoxide and EDC sequential double-crosslinked hyaluronate material was dried and subjected to an in vitro hyaluronidase degradation test in 0.15 M NaCl solution. The results are shown in Table 1.

### COMPARATIVE EXAMPLE 1

The same formulation as example 1 was used to produce a hydrogel without any crosslinking agent and crosslinking reaction. The same film forming method as example 1 formed a film for in vitro hyaluronidase degradation testing.

### COMPARATIVE EXAMPLE 2

A film was produced and tested as described in example 1, except that only one crosslinking reaction was performed using EDC as the crosslinking agent. The concentration of crosslinking agent and the reaction temperature and time are shown in Table 1.

### COMPARATIVE EXAMPLE 3

A film was produced and tested as described in example 1, except that only one crosslinking reaction was performed using epoxide as the crosslinking agent. The concentration of crosslinking agent and the reaction temperature and time are shown in Table 1.

TABLE 1

| | | Comp. | Comp. | Comp. |
|---|---|---|---|---|
| | Ex. 1 | Ex. 1 | Ex. 2 | Ex. 3 |
| Material type | Film | film | film | film |
| EDC crosslinking agent | 2 | — | 4 | — |
| concentration in first | | | | |
| crosslinking reaction, wt % | | | | |
| (acetone/water = 70/30 v/v) | | | | |
| Temperature(° C.)/time(min.) | 35/60 | — | 35/60 | — |
| for EDC crosslinking | | | | |
| EGDGE crosslinking agent | 2 | — | — | 4 |
| concentration in second | | | | |
| crosslinking reaction, wt % | | | | |
| (acetone/water = 70/30 v/v) | | | | |
| Temperature(° C.)/time (hr) | 35/2 | — | — | 35/4 |
| for epoxide crosslinking | | | | |
| in vitro hyaluronidase | 0.08% | 43.5% | 0.97% | 0.66% |
| degradation (220 U/mL, 35° C., | | | | |
| overnight) | | | | |

As the data shown in Table 1, the product produced by the present method exhibits a superior bio-degradation resistance to comparative examples 1, 2, and 3.

### EXAMPLE 2

### Method for Producing Epoxide-EDC Sequential Double-Crosslinked Hyaluronate Material

A solution of sodium hyaluronate powder (0.1 g) containing 1.0 meq (mili-equivalent) of hydroxyl groups in distilled water (10 ml) was prepared at room temperature. The solution of HA was preheated at 35° C., with a specific amount of ethylene glycol diglycidyl ether (EDGDE) added and mixed to perform the crosslinking reaction at a predetermined temperature and time as shown in Table 2. The EDGDE crosslinked HA solution was poured into a plate mold made of Teflon, and dried in an oven at 35° C., giving a film. The film was washed in a cleaning solution (a solution of 80% by weight of acetone in water) and distilled water separately and dried in an oven at 35° C. The dried film was placed in an EDC crosslinking agent solution (5% by weight of EDC in a solvent of acetone/water (80/20 v/v)) to perform a crosslinking reaction at a constant temperature of 35° C. for 3 hours, as shown in Table 2. The resulting sequential double-crosslinked hyaluronate material film was washed in a cleaning solution (acetone/water: 70/30 v/v)), then dried in an oven at 35° C., and subjected to an in vitro hyaluronidase degradation test. The results are shown in Table 2,

### EXAMPLE 3

A film was produced and tested as described in example 2, except that the concentration of EDC for crosslinking reaction was 10% by weight. The concentration of crosslinking agent and the reaction temperature and time are shown in Table 2. The product of hyaluronic acid crosslinked by only epoxide and the product of hyaluronic acid double crosslinked by epoxide and carbodiimide sequentially were subjected to an analysis by FTIR spectroscopy. The resulting spectra are shown in FIG. 1 and FIG. 2 respectively.

### EXAMPLE 4

A film was produced and tested as described in example 2, except that the concentration of EDC for crosslinking reaction was 20% by weight. The concentration of crosslinking agent and the reaction temperature and time are shown in Table 2.

### COMPARATIVE EXAMPLE 4

The same formulation as example 2 was used to produce a HA solution without any crosslinking reagent and crosslinking reaction. The same film forming method as example 2 was used to form a film for in vitro hyaluronidase degradation test.

### COMPARATIVE EXAMPLE 5

A film was produced and tested as described in example 2, except that only one crosslinking reaction was performed with EGDGE as the crosslinking agent. The concentration of crosslinking agent and the reaction temperature and time are shown in Table 2.

TABLE 2

| | | | | Comp. | Comp. |
|---|---|---|---|---|---|
| | Ex. 2 | Ex. 3 | Ex. 4 | Ex. 4 | Ex. 5 |
| Material type | film | film | film | film | film |
| EGDGE crosslinking | 10 | 10 | 10 | — | 10 |
| agent concentration | | | | | |
| in first crosslinking | | | | | |
| reaction, wt % | | | | | |
| (acetone/water = | | | | | |
| 80/20 v/v) | | | | | |
| Temperature(° C.)/ | 35/4 | 35/4 | 35/4 | — | 35/4 |
| time (hr) for epoxide | | | | | |
| crosslinking | | | | | |
| EDC crosslinking | 5 | 10 | 20 | — | — |
| agent concentration | | | | | |
| in second crosslink- | | | | | |
| ing reaction, wt % | | | | | |
| (acetone/water = | | | | | |
| 80/20 v/v) | | | | | |
| Temperature(° C.)/ | 35/3 | 35/3 | 35/3 | — | — |
| time (hr) for EDC | | | | | |
| crosslinking | | | | | |
| in vitro hyaluron- | 0.35% | 0.12% | 0.15% | 32.8% | 2% |
| idase degradation | | | | | |
| (220 U/mL, 35° C., | | | | | |
| overnight) | | | | | |

As shown in Table 2, products produced from examples 2, 3, and 4 in the present invention exhibited superior bio-degradation resistance compared to comparative examples 4 and 5.

### EXAMPLE 5

### Method for Producing Epoxide-EDC Sequential Double-Crosslinked Hyaluronate Hydrogel

To an HA (molecular weight: 2.2×10⁵) solution with a solid content of 20% and pH of 10 was added EX-861 (trade mark, sold by Nagase company, polyethylene glycol diglycidyl ether) in a ratio of crosslinking equivalent of HA:EX-861=1:4, and the resultant mixture was mixed uniformly and allowed to react at room temperature for 4 hours, giving an HA hydrogel. The resultant product was washed with and immersed for several days in a 50% alcohol solution, crushed, and freeze dried, resulting a powder. The resulting powder (HA/EX-861) was immersed in water having a pH value of 4.7 and subjected to the second crosslinking reaction with EDC in a ratio of crosslinking equivalent of HA:EDC=1:4) at room temperature for 4 hours, and then placed in a dialysis membrane for overnight dialysis in water. The resultant hydrogel was freeze-dried and subjected to an in vitro hyaluronidase degradation test.

### COMPARATIVE EXAMPLE 6

The same formulation as example 5 was used to produce a hydrogel without any crosslinking reagent and crosslinking reaction. The same film forming method as example 1 is used to form a film for in vitro hyaluronidase degradation test.

### COMPARATIVE EXAMPLE 7

A hydrogel was produced and tested as described in example 5, except that only one crosslinking reaction was performed with EX-861 epoxide (HA:epoxide=1:8 in equivalent) as the crosslinking agent. The concentration of crosslinking agent and the reaction temperature and time are shown in Table 3.

TABLE 3

| | | Comp. | Comp. |
|---|---|---|---|
| | Ex. 5 | Ex. 6 | Ex. 7 |
| Crosslinking equivalent | 1:4 | — | 1:8 |
| ratio for EX-861 in first | | | |
| crosslinking reaction, | | | |
| (HA:EX-861) | | | |
| Temperature(° C.)/time(hr) | 25/4 | — | 25/4 |
| for epoxide crosslinking | | | |
| Crosslinking equivalent | 1:4 | — | — |
| ratio for EDC in second | | | |
| crosslinking reaction, | | | |
| (HA:EDC) | | | |
| Temperature(° C.)/time(hr) | 25/4 | — | — |
| for EDC crosslinking | | | |
| in vitro hyaluronidase | 10.7% | 100% | 73.57% |
| degradation (220 U/mL, | | | |
| 35° C., overnight) | | | |

As shown in Table 3, the product produced from example 5 in the present invention exhibited superior bio-degradation resistance compared to comparative examples 6 and 7.

### EXAMPLE 6

### Method for Producing EDC-Epoxide Sequential Double-Crosslinked Hyaluronate Hydrogel

To an HA (molecular weight: 2.2×10⁵) solution with a solid content of 2.5% and pH of 4.7, EDC in a ratio of crosslinking equivalent of HA:EDC=1:8) was slowly added and the resultant mixture was mixed uniformly and allowed to react at room temperature for 4 hours, giving an HA hydrogel. The resulting product was washed with and immersed for five days in a 50% alcohol solution, crushed, and freeze dried, resulting in a powder. The powder (HA/EDC) was immersed in water having a pH value of 10 and subjected to the second crosslinking reaction with EX-810 (trade mark, sold by Nagase company, EDGDE, ethylene glycol diglycidyl ether) in a ratio of crosslinking equivalent of HA:EX-861=1:20 at room temperature for 4 hours, giving an HA hydrogel, and then placed in a dialysis membrane for overnight dialysis in water. The resultant hydrogel was freeze-dried and subjected to an in vitro hyaluronidase degradation test.

### COMPARATIVE EXAMPLE 8

The same formulation as example 6 was used to produce a hydrogel without any crosslinking reagent and crosslinking reaction. The same film forming method as example 1 was used to form a film for in vitro hyaluronidase degradation test.

### COMPARATIVE EXAMPLE 9

An EDC-crosslinked hyaluronate material was produced in one crosslinking reaction with EDC (HA:EDC=1:8 in equivalent) as the crosslinking agent. The concentration of crosslinking agent and the reaction temperature and time are shown in Table 4.

TABLE 4

| | | Comp. | Comp. |
|---|---|---|---|
| | Ex. 6 | Ex. 8 | Ex. 9 |
| Crosslinking equivalent | 1:8 | — | 1:8 |
| ratio for EDC in first | | | |
| crosslinking reaction, | | | |
| (HA:EDC) | | | |
| Temperature(° C.)/time(hr) | 25/4 | — | 25/4 |
| for EDC crosslinking | | | |
| Crosslinking equivalent | 1:20 | — | — |
| ratio for EX-810 in second | | | |
| crosslinking reaction, | | | |
| (HA:EX-810) | | | |
| Temperature(° C.)/time(hr) | 25/4 | — | — |
| for epoxide crosslinking | | | |
| in vitro hyaluronidase | 5.88% | 72.38% | 69.09% |
| degradation (220 U/mL, | | | |
| 35° C., overnight) | | | |

### EXAMPLE 7

### Method for Producing EDC-Epoxide Sequential Double-Crosslinked Hyaluronate Hydrogel

To an HA (molecular weight: 2.2×10⁵) solution with a solid content of 2.5% and pH of 4.7, EDC was added slowly and the resultant mixture was mixed uniformly, allowed to react at room temperature for 4 hours, subjected to overnight dialysis, and freeze dried, giving an HA powder. The powder (HA/EDC) was dissolved in water having a pH value of 10 and subjected to the second crosslinking reaction with EX-810 at room temperature for 4 hours, giving an HA hydrogel. The hydrogel was washed with a 50% alcohol solution, freeze-dried, and subjected to an in vitro hyaluronidase degradation test.

### COMPARATIVE EXAMPLE 10

The same formulation as example 7 was used to produce a hydrogel without any crosslinking reagent and crosslinking reaction. The same film forming method as example 1 was used to form a film for in vitro hyaluronidase degradation test.

### COMPARATIVE EXAMPLE 11

In the same way as example 7, a hyaluronate hydrogel was produced, except that only one crosslinking reaction with EDC (HA:EDC=1:16 in equivalent) as the crosslinking agent was performed. The concentration of crosslinking agent and the reaction temperature and time are shown in Table 5.

TABLE 5

| | | Comp. | Comp. |
|---|---|---|---|
| | Ex. 7 | Ex. 10 | Ex. 11 |
| Crosslinking equivalent | 1:16 | — | 1:16 |
| ratio for EDC in first | | | |
| crosslinking reaction, | | | |
| (HA:EDC) | | | |
| Temperature(° C.)/time(hr) | 25/4 | — | 25/4 |
| for epoxide crosslinking | | | |
| Crosslinking equivalent | 1:20 | — | — |
| ratio for EX-810 in second | | | |
| crosslinking reaction, | | | |
| (HA:EX-810) | | | |
| Temperature(° C.)/time(hr) | 25/4 | — | — |
| for EDC crosslinking | | | |
| in vitro hyaluronidase | 0.1% | 72.38% | 31.93% |
| degradation (220 U/mL, | | | |
| 35° C., overnight) | | | |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for producing double-crosslinked hyaluronate material, comprising the steps of;
(a) subjecting hyaluronic acid or a salt thereof to a first crosslinking reaction using either an epoxide compound or a carbodiimide compound as a crosslinking agent, and
(b) subjecting the product obtained from step (a) to a second crosslinking reaction using the epoxide compound or carbodiimide compound not used in step (b) as a crosslinking agent, thereby obtaining a double crosslinked hyaluronate material.

2. The method as claimed in claim 1, wherein the epoxide compound is a polyfunctional epoxide compound.

3. The method as claimed in claim 2, wherein the epoxide compound is 1,4-butanediol diglycidyl ether (BDDE), ethylene glycol diglycidyl ether (EGDGE), 1,6-hexanediol diglycigyl ether, polyethylene glycol diglycidyl ether, polypropylene glycol diglycidyl ether, polytetramethylene glycol digylcidyl ether, neopentyl glycol digylcidyl ether, polyglycerol polyglycidyl ether, diglycerol polyglycidyl ether, glycerol polyglycidyl ether, tri-methylolpropane polyglycidyl ether, pentaerythritol polyglycidyl ether, sorbitol polyglycidyl ether, or a combination thereof.

4. The method as claimed in claim 1, wherein the stoichiometry ratio of hyaluronic acid or a salt thereof to the epoxide compound in the crosslinking reaction is about 1:50 to 1:1 by crosslinking equivalent.

5. The method as claimed in claim 1, wherein the epoxide compound is in a solution with a concentration of about 1 to 30% by weight.

6. The method as claimed in claim 1, wherein the temperature for crosslinking reaction using the epoxide compound as the crosslinking agent is between about 20 and 60° C.

7. The method as claimed in claim 1, wherein the time for crosslinking reaction with the epoxide compound as the crosslinking agent is between 10 minutes and 12 hours.

8. The method as claimed in claim 1, wherein the carbodiimide compound is 1-methyl-3-(3-dimethylaminopropyl)-carbodiimide, 1-ethyl-3-(3-dimethylaminopropyl)carbodiimide, 3-(3-dimethylaminopropyl)-3-ethylcarbodiimide, or a combination thereof.

9. The method as claimed in claim 1, wherein the stoichiometry ratio of hyaluronic acid or a salt thereof to the carbodiimide compound in the crosslinking reaction is about 1:50 to 1:1 by crosslinking equivalent.

10. The method as claimed in claim 1, wherein the carbodiimide compound is in a solution with a concentration of about 0.5 to 30% by weight.

11. The method as claimed in claim 1, wherein the temperature for crosslinking reaction using the carbodiimide compound as the crosslinking agent is between about 20 and 60° C.

12. The method as claimed in claim 1, wherein the time for crosslinking reaction using the carbodiimide compound as the crosslinking agent is between 30 minutes and 12 hours.

13. The method as claimed in claim 1, wherein the hyaluronic acid or a salt thereof is contained in a material.

14. The method as claimed in claim 1, wherein, in step (a), the hyaluronic acid or a salt thereof is preformed into a solution, film, membrane, powder, microsphere, fiber, filament, matrix, porous substrate or gel before undergoing the first crosslinking reaction.

15. The method as claimed in claim 14, wherein the film is formed by placing a solution of hyaluronic acid or a salt thereof with a concentration of about 1 to 20% by weight in a mold and drying at a temperature between 25 and 70° C.

16. The method as claimed in claim 14, wherein the film has a thickness of about 10 to 500 μm.

17. The method as claimed in claim 14, wherein the microsphere is formed by intermittently extruding and dropping a solution of hyaluronic acid or a salt thereof into a coagulant.

18. The method as claimed in claim 14, wherein the microsphere has a diameter of about 2.0 to 0.1 mm.

19. The method as claimed in claim 14, wherein the fiber is formed by extruding a solution of hyaluronic acid or a salt thereof into a coagulant.

20. The method as claimed in claim 1, wherein, in step (b), the product obtained from step (a) is preformed into a solution, film, membrane, powder, microsphere, fiber, filament, matrix, porous substrate or gel before undergoing the second crosslinking reaction.

21. The method as claimed in claim 20, wherein the film is formed by placing the product obtained from step (a) in a mold and drying at a temperature between 25 and 70° C.

22. The method as claimed in claim 20, wherein the film has a thickness of about 10 to 500 μm.

23. The method as claimed in claim 20, wherein the microsphere is formed by intermittently extruding and dropping the product obtained from step (a) into a coagulant.

24. The method as claimed in claim 20, wherein the microsphere has a diameter of about 2.0 to 0.1 mm.

25. The method as claimed in claim 20, wherein the fiber is formed by extruding the product obtained from step (a) into a coagulant.

26. The method as claimed in claim 1, after step (b), further comprising the following step:
(c) washing and drying the double-crosslinked hyaluronate material obtained in step (b).

27. The method as claimed in claim 26, wherein step (c) includes washing and drying at a temperature less than 60° C.

28. The method as claimed in claim 1, wherein the double-crosslinked hyaluronate material is in the form of solution, film, membrane, powder, microsphere, fiber, filament, matrix, porous substrate or gel.

29. A double-crosslinked hyaluronate material produced by the method as claimed in claim 1.
